(19) United States
(12) Patent Application Publication
(10) Pub. No.: US 2017/0228669 A1
(43) Pub. Date: Aug. 10, 2017

(54) METHOD, APPARATUS, AND SYSTEM FOR DESCRIBING BUSINESS MODEL OF ORGANIZATION, AND COMPUTER READABLE STORAGE MEDIUM

(71) Applicant: Shenzhen Development Promotion Centre for Enterprises, SHENZHEN GUANGDONG (CN)

(72) Inventors: Wei WEI, SHENZHEN GUANGDONG (CN); Wuxiang ZHU, SHENZHEN GUANGDONG (CN)

(73) Assignee: Shenzhen Development Promotion Centre for Enterprises, SHENZHEN GUANGDONG (CN)

(21) Appl. No.: 15/018,080

(22) Filed: Feb. 8, 2016

(51) Int. Cl. G06Q 10/06; G06Q 40/00

(52) U.S. Cl. CPC G06Q 10/067; G06Q 40/12

(57) ABSTRACT

A method, an apparatus, and a system for describing a business model of an organization, and a computer readable storage medium are disclosed. Data of an association relationship between a stakeholder and a resource, data of an association relationship between an activity and a resource, data of an association relationship between a stakeholder and an activity, and data of a transaction relationship between stakeholders are generated according to stakeholder information of an organization, resource information owned by the organization, activity information of the organization, and information of a transaction mode between stakeholders, and thereby an effective quantitative analysis method or apparatus is provided for describing a business model of the organization.

### TECHNICAL FIELD

The present invention relates to the data analysis processing field, and in particular, to a method, an apparatus, and a system for describing a business model of an organization, and a computer readable storage medium.

### BACKGROUND

With continuous advancement of science and technology and continuous development of innovations, how to successfully apply a new invention or creative idea to business operation and organization development to achieve operational performance is a common concern in various industries of the society. The concept of business model is put forward just to set up a bridge between creative idea and organization operation.

Since 1950s, more than 200 business models have been defined in the academic field. Lack of a unified definition, in particular, lack of an effective analysis tool, greatly constrains realization of value of the concept of business model.

A good creative idea, a good product, and an innovative technology all require a suitable business model to match them, so that their real value can be realized. The value created by the same technology, product, or concept by using different business models differs greatly. Therefore, in a development process of an organization, the organization needs to select a business model cautiously to fully explore the value of the organization. A description of an existing business model of the organization provides an idea and a basis for a future improvement, rebuilding, or innovation of the business model of the organization.

In expressing the business model of the organization, an existing theory for analyzing the business model mainly lays an emphasis on qualitative analysis, and cannot perform a unified comparison and quantitative analysis on the business model of the organization. Therefore, it is very difficult to make a longitudinal comparison in the organization and a horizontal comparison between organizations for the business model, and the organization can hardly explicitly analyze and refine an operational performance improvement achieved based on a business model improvement, which constrains realization of the value of the business model in the organization.

### SUMMARY

Objectives of the present invention are to provide a method, an apparatus, and a system for describing a business model of an organization, and a computer readable storage medium.

A method for describing a business model of an organization is disclosed, where the method includes the following steps:

generating data of an association relationship between a stakeholder and a resource according to stakeholder information of the organization and resource information owned by the organization;

generating data of an association relationship between an activity and a resource according to activity information of the organization and the resource information owned by the organization;

generating data of an association relationship between a stakeholder and an activity according to the stakeholder information of the organization and the activity information of the organization; and

generating data of a transaction relationship between stakeholders according to information of a transaction mode between stakeholders of the organization; where

the resources are features that are controlled by the organization to implement a strategy of the organization and used to improve operational performance and efficiency of the organization, and the activities are actions of stakeholders of the organization.

An apparatus for describing a business model of an organization is disclosed, where the apparatus includes:

a stakeholder-resource association relationship data generation unit, configured to generate data of an association relationship between a stakeholder and a resource according to stakeholder information of the organization and resource information owned by the organization;

an activity-resource association relationship data generation unit, configured to generate data of an association relationship between an activity and a resource according to activity information of the organization and the resource information owned by the organization;

a stakeholder-activity association relationship data generation unit, configured to generate data of an association relationship between a stakeholder and an activity according to the stakeholder information of the organization and the activity information of the organization; and

a stakeholder transaction relationship data generation unit, configured to generate data of a transaction relationship between stakeholders according to information of a transaction mode between stakeholders of the organization; where

the resources are features that are controlled by the organization to implement a strategy of the organization and used to improve operational performance and efficiency of the organization; and

the activities are actions of stakeholders of the organization.

A system for describing a business model of an organization is disclosed, where the system includes:

a bus, configured to transmit signaling and data;

a user interface adapter, configured to connect an input device to the bus, and receive stakeholder information of the organization, resource information owned by the organization, activity information of the organization, and information of a transaction mode between stakeholders of the organization, which are input by a user;

a display adapter, configured to connect a display device to the bus, and display data of an association relationship between a stakeholder and a resource, data of an association relationship between an activity and a resource, data of an association relationship between a stakeholder and an activity, and data of a transaction relationship between stakeholders; and

a business model description apparatus, configured to receive the stakeholder information of the organization, the resource information owned by the organization, the activity information of the organization, and the information of the transaction mode between stakeholders of the organization, which are transmitted by the user interface adapter through the bus, generate data of an association relationship between a stakeholder and a resource, data of an association relationship between an activity and a resource, data of an association relationship between a stakeholder and an activity, and data of a transaction relationship between stakeholders, and transmit the data to the display adapter through the bus.

A computer readable storage medium is disclosed, where the computer readable storage medium stores a computer program instruction executable by a computer, and when the computer executes the computer program instruction, the computer executes a method for describing a business model, where the method for describing a business model includes:

generating data of an association relationship between a stakeholder and a resource according to stakeholder information of an organization and resource information owned by the organization;

generating data of an association relationship between an activity and a resource according to activity information of the organization and the resource information owned by the organization;

generating data of an association relationship between a stakeholder and an activity according to the stakeholder information of the organization and the activity information of the organization; and

generating data of a transaction relationship between stakeholders according to information of a transaction mode between stakeholders of the organization; where

the resources are features that are controlled by the organization to implement a strategy of the organization and used to improve operational performance and efficiency of the organization, and the activities are actions of stakeholders of the organization.

In specific implementation manners of a method and an apparatus for describing a business model according to the present invention, a stakeholder, a resource, an activity, and a transaction mode of an organization are input, and a corresponding association relationship between every two thereof is generated for describing an existing business model of the organization, and thereby an effective quantitative analysis method or apparatus is provided for describing the business model of the organization.

### BRIEF DESCRIPTION OF THE DRAWINGS

FIG. 1 is a flowchart of a specific implementation manner of a method for describing a business model of an organization according to the present invention;

FIG. 2 is a table of association relationships between stakeholders and resources involved in a specific implementation manner of a method for describing a business model of an organization according to the present invention;

FIG. 3 is a table of association relationships between activities and resources involved in a specific implementation manner of a method for describing a business model of an organization according to the present invention;

FIG. 4 is a table of association relationships between stakeholders and activities involved in a specific implementation manner of a method for describing a business model of an organization according to the present invention;

FIG. 5 is a table of transaction relationships between stakeholders involved in a specific implementation manner of a method for describing a business model of an organization according to the present invention;

FIG. 6 is a schematic block diagram of a specific implementation manner of an apparatus for describing a business model of an organization according to the present invention; and

FIG. 7 is a schematic block diagram of a specific implementation manner of a system for describing a business model of an organization according to the present invention.

### DESCRIPTION OF THE EMBODIMENTS

Development and operation of an organization are dependent upon input and output of stakeholders related to the organization and transactions performed with the stakeholders.

In the present invention, stakeholder information, activity information, resource information, and transaction mode information of the organization are input; and a relationship between a stakeholder and a resource owned by the stakeholder, a relationship between an activity and a resource used by the activity, a relationship between a stakeholder and an activity, and a transaction relationship between stakeholders are generated. Accordingly, relationships of interests between various entities and business processes thereof in a business model of the organization can be seen clearly, so that the business model of the organization can be analyzed.

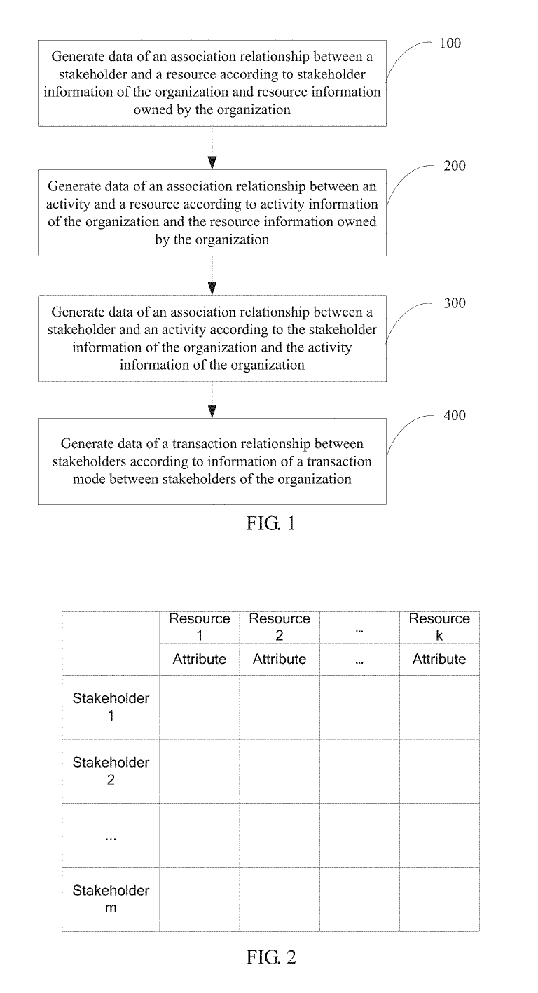

FIG. 1 shows a specific implementation manner of a method for describing a business model of an organization according to the present invention. The method includes:

Step 100: Generate data of an association relationship between a stakeholder and a resource according to stakeholder information of the organization and resource information owned by the organization.

In the present invention, stakeholders are any stakeholders that are affected by a decision or an action of the organization, in internal and external environments of the organization. The stakeholders may be external stakeholders, for example, creditors, suppliers, retailers, and governments, and may be internal stakeholders, for example, employees and shareholders. To define a stakeholder of the organization, it is necessary to determine whether a decision or an action of the stakeholder is affected by the organization. For example, a supplier of an enterprise is apparently a stakeholder of the enterprise, because a decision of the supplier is apparently affected by the enterprise.

Resources refer to features that are controlled by the organization to implement a strategy of the organization and used to improve operational performance and efficiency of the organization, including all properties, capacities, competitiveness, organization processes, organization features, data, information, knowledge, and the like.

In the present invention, an objective of generating data of an association relationship between a stakeholder and a resource according to acquired stakeholder information of the organization and resource information owned by the organization is to determine whether a stakeholder fully uses a resource owned by the stakeholder, or whether an owner of a resource participates in an activity that requires the resource, in order to improve the business model of the organization.

In an embodiment of the present invention, the stakeholder information of the organization and the resource information owned by the organization may be input by a user in a set input interface or a table.

In an embodiment of the present invention, a table of relationships between stakeholders and resources shown in FIG. 2 may be generated and used to present data of association relationships between stakeholders and resources.

In the table, a horizontal coordinate is resource information owned by the organization, where an attribute of a resource includes a description of a resource characteristic, a vertical coordinate is stakeholder information of the organization; and a cross square may present data of an association relationship between a stakeholder and a resource owned by the organization.

In an embodiment of the present invention, the data of an association relationship between a stakeholder and a resource owned by the organization in each square in FIG. 2 is determined according to the following expression:

$$\frac{Level}{Owned}$$

where, Owned indicates whether the stakeholder owns the resource, and its value may be 0 or 1, where 0 indicates that the stakeholder does not have the resource, and 1 indicates that the stakeholder has the resource; and

Level indicates a level of ownership or control of the stakeholder over the resource, which may be described qualitatively or quantitatively, for example, set to a high level, a middle level, or a low level.

By generating and recording association relationships between stakeholders and resources owned by the stakeholders, ownership of each resource in the business model of the organization may be fully defined, and a basis is provided for further analysis to determine whether a stakeholder fully uses a resource owned by the stakeholder, or whether an owner of a resource participates in an activity that requires the resource, and thereby reference data is provided for improving the business model of the organization.

Step 200: Generate data of an association relationship between an activity and a resource according to activity information of the organization and the resource information owned by the organization.

In the present invention, activities refer to specific actions of various stakeholders of the organization. For example, characteristics of production, research and development, sale, logistics, after-sales service, and activities may be specifically described by using attributes of activities.

The attributes of activities are used to specifically describe characteristics of a type of activity. For example, attributes of production refer to activities and processes of creating corporeal properties; attributes of research and development refer to systematic activities with clear goals, which are continuously carried out by various research institutes and enterprises in order to acquire new knowledge of science and technology (not including humanities and social science), creatively apply new knowledge of science and technology, or substantially improve technologies, products, and services.

By generating data of association relationships between activities and resources used by the activities, a relationship between each activity and a resource required by the activity in the business model of the organization is presented, and a match between an activity and a resource in the business model of the organization is determined accordingly.

In an embodiment of the present invention, the activity information of the organization and the resource information owned by the organization may be input by the user in a set input interface or a table.

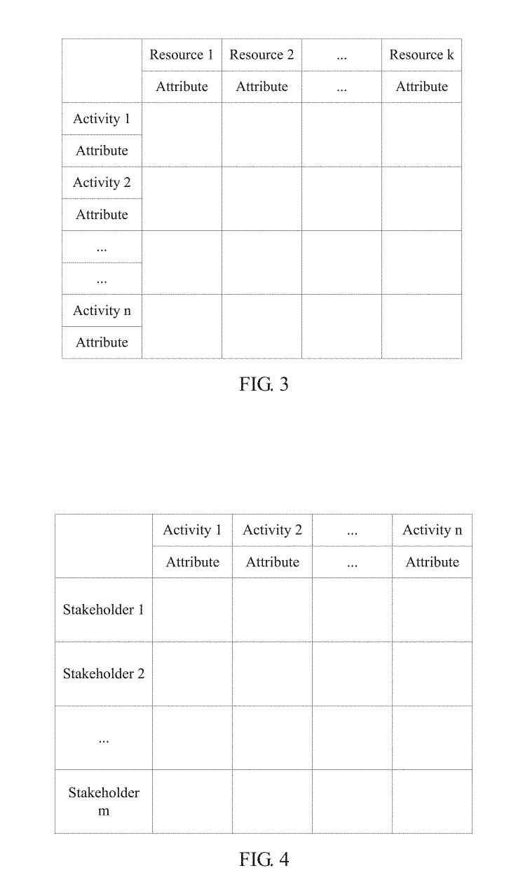

In an embodiment of the present invention, a table of association relationships between activities and resources shown in FIG. 3 may be generated and used to present data of association relationships between activities and resources.

In the table, a horizontal coordinate is resource information owned by the organization, where an attribute of a resource includes a description of a resource characteristic; a vertical coordinate is activity information of the organization, where an attribute of an activity is used to describe a characteristic of the activity; and a cross square may present data of an association relationship between an activity of the organization and a resource owned by the organization.

In an embodiment of the present invention, the data of an association relationship between an activity of the organization and a resource owned by the organization in a square in FIG. 3 is determined according to the following expression:

$$\frac{Input Process Output}{Required} , Capacity , Rank$$

where, Required indicates whether the activity requires the resource, and its value may be 0 or 1, for example, 0 indicates that the resource is not required, and 1 indicates that the resource is required;

Input, Process, and Output respectively indicate whether the resource may be used in input, processing, and generation of the activity, and their value may be 0 or 1, for example, 0 indicates use, and 1 indicates non-use;

Capacity indicates a capacity formed in the activity by using the resource; and

Rank indicates strength and stability of the capacity formed in the activity.

In the present invention, capacities of the organization may be categorized into five types: organization capacity, material capacity, transaction capacity, knowledge capacity, and opportunity discovery and recognition capacity. The five capacities may be set to different values respectively. By setting values for the five capacities, strength and stability of the capacities are evaluated, and further, advantages and disadvantages of the business model of the organization may be determined, and a clue is provided for subsequent business model design. The setting of a capacity value depends on strength of the capacity. If the capacity value is greater than an average value in an industry, it indicates a high capacity. If the capacity value is equal to the average value in the industry, it indicates a moderate capacity. If the capacity value is less than the average value in the industry, it indicates a low capacity.

The organization capacity refers to a capacity of undertaking a specific business activity by the organization, for example, a formal report structure, a formal or informal plan, a control and coordination system, a culture and reputation, informal relationships between employees and or internal groups, and an informal relationship between the organization and an environment.

The material capacity includes capacities of material supply, component manufacturing, component assembly and test, product manufacturing, warehousing, sales channel setup, and distribution.

The transaction capacity includes order processing, delivery management, process control, inventory management, forecast, complaint handling, procurement management, payment processing, receivables management, and the like.

The knowledge capacity includes a product design and development capacity, a brand building and management capacity, a customer requirement guidance capacity, a market information acquiring and processing capacity, and the like.

The opportunity discovery and recognition capacity refers to a capacity of sensing and perceiving an environment and an opportunity, and determining nature of the opportunity.

In a process of assigning values to the foregoing formula, a capacity of the organization may be included into the foregoing five capacities, and described in detail, for example, transaction capacity sales capacity, and knowledge capacity research and development capacity. By categorizing a capacity of the organization, the capacity may be defined accurately, and an idea is provided for business model design.

Step 300: Generate data of an association relationship between a stakeholder and an activity according to the stakeholder information of the organization and the activity information of the organization.

In the present invention, by generating data of association relationships between stakeholders and activities, a relationship between each activity and a stakeholder responsible for the activity in the business model of the organization, that is, which stakeholder participates in an activity, may be presented, so that a specific activity of each stakeholder in the business model of the organization is made clear.

In an embodiment of the present invention, the stakeholder information of the organization and the activity information of the organization may be input by the user in a set input interface or a table.

In an embodiment of the present invention, a table of association relationships between stakeholders and activities shown in FIG. 4 may be generated and used to present data of association relationships between stakeholders and activities.

In the table, a horizontal coordinate is stakeholder information of the organization; a vertical coordinate is activity information of the organization, where an attribute of an activity is used to describe a characteristic of the activity; and a cross square may present data of an association relationship between a stakeholder of the organization and an activity of the organization.

In an embodiment of the present invention, the data of an association relationship between a stakeholder of the organization and an activity of the organization in a square in FIG. 4 is determined according to the following expression:

$$\frac{Capacity Rank}{Participated}$$

where, Participated indicates whether the stakeholder participates in the activity, and its value may be 0 or 1, where 0 indicates that the stakeholder does not participate in the activity, and 1 indicates that the stakeholder participates in the activity;

Capacity indicates a capacity formed by the stakeholder by participating in the activity; and

Rank indicates strength of the capacity formed in the activity.

Step 400: Generate data of a transaction relationship between stakeholders according to information of a transaction mode between stakeholders of the organization.

In the present invention, a transaction mode refers to a combination of six parameters: a revenue and expenditure source of an enterprise under analysis, a mode that meets a requirement of a stakeholder, a transaction structure between stakeholders, roles, a revenue and expenditure mode, and a cash flow structure. The transaction structure specifies that the enterprise under analysis transacts content (what to transact) at a transaction price (how to price) with a stakeholder (whom to transact with) by using a transaction mode (how to transact).

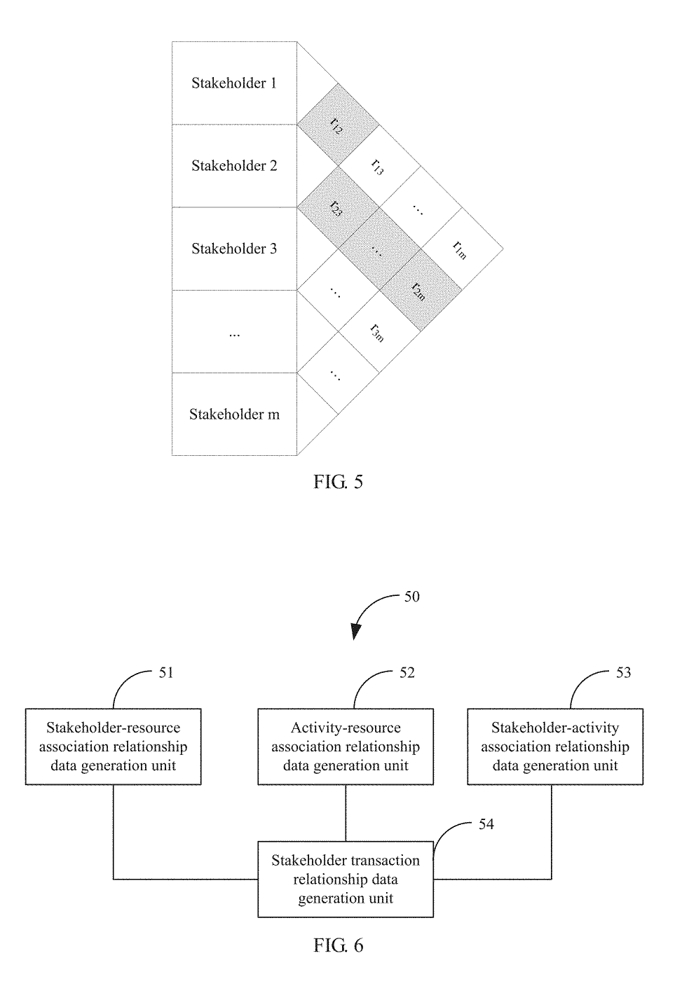

In an embodiment of the present invention, a table of transaction relationships between stakeholders shown in FIG. 5 may be generated and used to present data of transaction relationships between stakeholders and record transaction modes, transaction content, and the like between various stakeholders.

In FIG. 5, each diamond box indicates a transaction relationship between two stakeholders. For example, r₁₂, r₂₃, . . . , r₂ₘ displayed as shadow parts respectively indicate a transaction relationship between a stakeholder 2 and a stakeholder 1, a transaction relationship between the stakeholder 2 and a stakeholder 3, . . . , a transaction relationship between the stakeholder 2 and a stakeholder m.

In an embodiment of the present invention, a transaction relationship between stakeholders in a diamond box in FIG. 5 is determined according to the following expression:

$$\frac{{T}_{1} \text{∼} {T}_{i}}{G}$$

where, T₁ to Tᵢ are identifiers of attribute information of the transaction mode between stakeholders, and i is a natural number greater than or equal to 1;

G is a governing relationship between entities, for example, an employment relationship or a pure market cooperation relationship; and

the entities include the organization and stakeholders.

In an embodiment of the present invention, data of a transaction relationship between stakeholders is described by using six attributes T₁ to T₆, and a corresponding value of each attribute may be preset.

(1) T₁ indicates information of a mode that meets a requirement, for example, by using a direct distributor, a dealer, an agent, a self-established office, a franchise, or an online transaction platform.

(2) T₂ indicates revenue and expenditure source information of a transaction. For example, which stakeholders are revenue sources? Does the revenue come from a direct customer or a third-party customer? Which stakeholders bear the cost? Is the cost borne by the organization itself or a third partner? For example, generally, sales revenue of the organization comes from a terminal customer; a sales commission is given to a sales representative; or a television station provides television programs for the audience, the direct customers, but collects an advertising fee from an advertiser, the third-party customer.

(3) T₃ indicates revenue and expenditure mode information of the transaction. There are mainly three revenue modes: fixed revenue, residual revenue, and shared revenue. Expenditure modes include a slotting fee, a refueling charge, a toll charge, a shared expense, and compound pricing.

It is assumed that transaction parties are defined as A and B.

If revenue of A (or B) is not affected by output, the fixed revenue is fixed revenue obtained by A (or B). If revenue of A (or B) is affected by output, and generally, the greater the output is, the higher the revenue is, and vice versa, the residual revenue is residual revenue obtained by A (or B). For example, a commercial land agent of a large shopping mall collects a rent from a merchant, and the rent amount does not increase or decrease with the increase or decrease of output (that is, the total sales amount in every month) of the entire shopping mall, and therefore, a fixed revenue is obtained by the commercial land agent. The merchant pays the fixed rent to the commercial land agent, and the revenue of the merchant is affected by the output (monthly sales amount), and therefore, a residual revenue is obtained by the merchant.

If revenue of A and revenue of B are both fixedly proportional to total output of A and B, the shared revenue is a shared revenue obtained by A (or B).

In the present invention, the fixed revenue, residual revenue, and shared revenue are all directed to a specific group of stakeholders or a specific cooperator. For a same organization, when the organization cooperates with different stakeholders, the revenue of the organization may vary.

The slotting fee is determined according to consumption qualifications, for example, a membership fee, a subscription fee, a buffet dinner, and a one-off sales expense.

The toll charge is determined according to the number of consumptions. For example, for a search advertisement, charging is performed according to a click-through rate; for a fitness card, charging is performed by times; for a coin washing machine, coins need to be inserted according to the number of washes.

A parking fee is a fee charged according to a consumption duration. For example, for an online game, charging is performed according to an online duration; for a call of a mobile phone, charging is performed according to a duration.

The refueling charge is determined according to consumption value, for example, determined according to cost, or determined by piece according to sold items of an online game.

The shared expense is determined according to value created for a customer, for example, a franchise fee, energy management contracting (EMC), and an investment fund.

Compound pricing means that a commodity or a service is not priced separately, but priced according to a combination thereof. For example, there are two types of tickets for an amusement park. One is a relatively expensive all-in-one ticket, which may be used for playing all games in the amusement park; and another is a ticket for entering the park only, and additional payment is needed for playing amusement facilities in the park. Another example is compound pricing of a Gillette razor-blade product, where customers are locked by using cheap razors, and then profits are earned by continuously selling blades with high gross profits.

(4) T₄ indicates cash flow structure information of the transaction.

A cash flow structure refers to an inflow structure and an outflow structure of a cash flow of the organization divided according to stakeholders, and corresponding cash flow forms. For example, capital of the organization is one investment for one return, or one investment for multiple returns, or zero variable cost investment for multiple returns. In addition, the cash flow structure further includes a description of use of financial instruments of the organization, that is, whether the organization uses modes of bank loaning, financial leasing, factoring, risk investment, and IPO for financing. In addition, a cash flow table of the organization needs to be analyzed.

(5) T₅ indicates information of roles of stakeholders in the transaction, and refers to roles assumed by stakeholders that have certain resource capacities in the transaction, for example, a supplier, a dealer, and a cooperative research and development institute.

(6) T₆ indicates information of a transaction structure, and refers to a topology with or without transactions between stakeholders, just as shown in the table of transaction relationships between stakeholders.

In an embodiment of the present invention, all of the six attributes T₁ to T₆ may be defined according to different content. That is, in the description of data of transaction relationships between various stakeholders, it is necessary to describe and analyze the six attributes between the stakeholders, where the structure attribute is directly represented by a table. According to a requirement, FIG. 5 may be expressed in combination with FIG. 2 or FIG. 4.

It should be noted that there is no necessary sequence between the foregoing steps 100, 200, 300, and 400, and that the process of analyzing the business model of the organization is a progressive continuous improvement process.

First, association relationships between stakeholders and resources, association relationships between resources and activities, and association relationships between stakeholders and activities are generated.

Then, relationships, transaction content, and transaction modes between various stakeholders are integrated into one large mapping table by using the transaction relationships between stakeholders.

This large table may clearly display in which mode each stakeholder of the organization performs a transaction with another stakeholder, what is transacted between the stakeholders, how transaction content is priced, how interests are settled between the two parties, what roles are played in an entire activity of the organization, as well as relationships of interests between various stakeholders and business processes thereof. All these are a crucial cut-in point for analyzing a business model of an organization.

In a specific implementation manner of a method for describing a business model of an organization according to the present invention, a stakeholder, a resource, an activity, and a transaction mode are determined and input, and tables in FIG. 1 to FIG. 4 are formed for describing and analyzing an existing business model of the organization. In this way, an idea for clearly describing relationships between various activities, resources, and stakeholders of the organization, and a presentation mode thereof are provided for the organization; an effective quantitative analysis method is provided for describing the business model of the organization; relationships and matches between various stakeholders, resources, and activities of the organization in a business environment may be defined; links occupied by the stakeholders in the activities of the organization and output of the stakeholders in the links are made clear.

In addition, a horizontal comparison and a longitudinal comparison may be performed on the business model of the organization for further improvements and enhancements, which helps to find an existing problem, a bottleneck, and a breakthrough in the organization, and lay a basis for future improvements and innovations. Furthermore, a comprehensive and complete perspective is provided for the organization, so that the organization can describe in detail and express the architecture, operation, and profit model of the organization by using the business model of the organization.

FIG. 6 shows a specific implementation manner of an apparatus for describing a business model of an organization according to the present invention. The apparatus 50 includes a stakeholder-resource association relationship data generation unit 51, an activity-resource association relationship data generation unit 52, a stakeholder-activity association relationship data generation unit 53, and a stakeholder transaction relationship data generation unit 54.

The stakeholder-resource association relationship data generation unit 51 is configured to generate data of an association relationship between a stakeholder and a resource according to stakeholder information of the organization and resource information owned by the organization.

In an embodiment of the present invention, the stakeholder information of the organization and the resource information owned by the organization may be input by a user in a set input interface or a table in the stakeholder-resource association relationship data generation unit 51.

In an embodiment of the present invention, the stakeholder-resource association relationship data generation unit 51 may generate a table of relationships between stakeholders and resources shown in FIG. 2, for presenting data of association relationships between stakeholders and resources.

In the table, a horizontal coordinate is resource information owned by the organization, where an attribute of a resource includes a description of a resource characteristic; a vertical coordinate is stakeholder information of the organization; and a cross square may present data of an association relationship between a stakeholder and a resource owned by the organization.

In an embodiment of the present invention, the data of an association relationship between a stakeholder and a resource owned by the organization in each square in FIG. 2 is determined according to the following expression:

$$\frac{Level}{Owned}$$

where, Owned indicates whether the stakeholder owns the resource, and its value may be 0 or 1, where 0 indicates that the stakeholder does not have the resource, and 1 indicates that the stakeholder has the resource; and

Level indicates a level of ownership or control of the stakeholder over the resource, which may be described qualitatively or quantitatively, for example, set to a high level, a middle level, or a low level.

The activity-resource association relationship data generation unit 52 is configured to generate data of an association relationship between an activity and a resource according to activity information of the organization and the resource information owned by the organization.

In an embodiment of the present invention, the activity information of the organization and the resource information owned by the organization may be input by the user in a set input interface or a table in the activity-resource association relationship data generation unit 52.

In an embodiment of the present invention, the activity-resource association relationship data generation unit 52 may generate a table of relationships between activities and resources shown in FIG. 3, for presenting data of association relationships between activities and resources.

In the table, a horizontal coordinate is resource information owned by the organization, where an attribute of a resource includes a description of a resource characteristic; a vertical coordinate is activity information of the organization, where an attribute of an activity is used to describe a characteristic of the activity; and a cross square may present data of an association relationship between an activity of the organization and a resource owned by the organization.

In an embodiment of the present invention, the data of an association relationship between an activity of the organization and a resource owned by the organization in a square in FIG. 3 is determined according to the following expression:

$$\frac{Input Process Output}{Required} , Capacity , Rank$$

where, Required indicates whether the activity requires the resource, and its value may be 0 or 1, for example, 0 indicates that the resource is not required, and 1 indicates that the resource is required;

Input, Process, and Output respectively indicate whether the resource may be used in input, processing, and generation of the activity, and their value may be 0 or 1, for example, 0 indicates use, and 1 indicates non-use;

Capacity indicates a capacity formed in the activity by using the resource; and

Rank indicates strength of the capacity formed in the activity.

The stakeholder-activity association relationship data generation unit 53 is configured to generate data of an association relationship between a stakeholder and an activity according to the stakeholder information of the organization and the activity information of the organization.

In an embodiment of the present invention, the stakeholder information of the organization and the activity information of the organization may be input by the user in a set input interface or a table in the stakeholder-activity association relationship data generation unit 53.

In an embodiment of the present invention, the stakeholder-activity association relationship data generation unit 53 may generate a table of relationships between stakeholders and activities shown in FIG. 4, for presenting data of association relationships between stakeholders and activities.

In the table, a horizontal coordinate is stakeholder information of the organization; a vertical coordinate is activity information of the organization, where an attribute of an activity is used to describe a characteristic of the activity; and a cross square may present data of an association relationship between a stakeholder of the organization and an activity of the organization.

In an embodiment of the present invention, the data of an association relationship between a stakeholder of the organization and an activity of the organization in a square in FIG. 4 is determined according to the following expression:

$$\frac{Capacity Rank}{Participated}$$

where, Participated indicates whether the stakeholder participates in the activity, and its value may be 0 or 1, where 0 indicates that the stakeholder does not participate in the activity, and 1 indicates that the stakeholder participates in the activity;

Capacity indicates a capacity formed by the stakeholder by participating in the activity; and

Rank indicates strength of the capacity formed in the activity.

The stakeholder transaction relationship data generation unit 54 is configured to generate data of a transaction relationship between stakeholders according to information of a transaction mode between stakeholders of the organization.

In an embodiment of the present invention, the stakeholder transaction relationship data generation unit 54 may generate a table of transaction relationships between stakeholders shown in FIG. 5, for presenting data of transaction relationships between stakeholders and recording transaction modes, transaction content, and the like between various stakeholders.

In an embodiment of the present invention, a transaction relationship between stakeholders in a diamond box in FIG. 5 is determined according to the following expression:

$$\frac{{T}_{1} \text{∼} {T}_{i}}{G}$$

where, T₁ to Tᵢ are identifiers of attribute information of the transaction mode between stakeholders, and i is a natural number greater than or equal to 1;

G is a governing relationship between entities, for example, an employment relationship or a pure market cooperation relationship; and

the entities include the organization and stakeholders.

In an embodiment of the present invention, the data of transaction relationships between stakeholders is described by using six attributes T₁ to T₆, including information of a mode that meets a requirement, revenue and expenditure source information of a transaction, revenue and expenditure mode information of the transaction, cash flow structure information of the transaction, information of roles in the transaction, and information of a transaction structure.

Association relationships between stakeholders and resources, association relationships between resources and activities, and association relationships between stakeholders and activities are generated by the foregoing units 51, 52, and 53. Then, relationships, transaction content, and transaction modes between various stakeholders may be integrated into one large mapping table by using the transaction relationships between stakeholders that are generated by the unit 54.

This large table may clearly display in which mode each stakeholder of the organization performs a transaction with another stakeholder, what is transacted between the stakeholders, how transaction content is priced, how interests are settled between the two parties, what roles are played in an entire activity of the organization, as well as relationships of interests between various stakeholders and business processes thereof. All these are a crucial cut-in point for analyzing a business model of an organization.

In a specific implementation manner of an apparatus for describing a business model of an organization according to the present invention, a stakeholder, a resource, an activity, and a transaction mode are determined and input, and tables in FIG. 1 to FIG. 4 are formed for describing and analyzing an existing business model of the organization. In this way, an idea for clearly describing relationships between various activities, resources, and stakeholders of the organization, and a presentation mode thereof are provided for the organization; an effective quantitative analysis method is provided for describing the business model of the organization; relationships and matches between various stakeholders, resources, and activities of the organization in a business environment may be defined; links occupied by the stakeholders in the activities of the organization and output of the stakeholders in the links are made clear.

In addition, a horizontal comparison and a longitudinal comparison may be performed on the business model of the organization for further improvements and enhancements, which helps to find an existing problem, a bottleneck, and a breakthrough in the organization, and lay a basis for future improvements and innovations. Furthermore, a comprehensive and complete perspective is provided for the organization, so that the organization can describe in detail and express the architecture, operation, and profit model of the organization by using the business model of the organization.

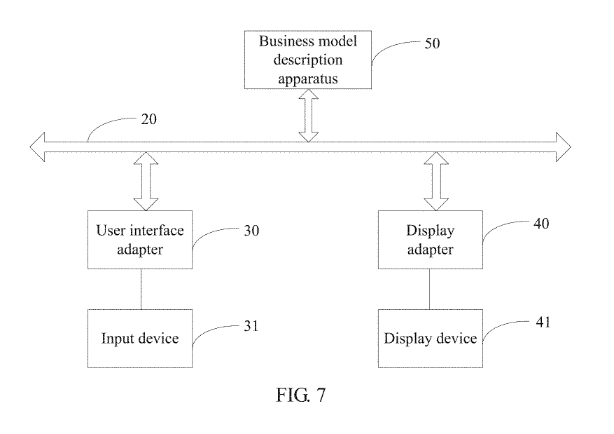

FIG. 7 shows a specific implementation manner of a system for describing a business model of an organization. The system includes:

a bus 20, configured to transmit signaling and data;

a user interface adapter 30, configured to connect an input device 31 to the bus 20, and receive stakeholder information of the organization, resource information owned by the organization, activity information of the organization, and information of a transaction mode between stakeholders of the organization, which are input by a user, where the input device includes but is not limited to a keyboard, a mouse, a speaker, a microphone, or the like;

a display adapter 40, configured to connect a display device 41 to the bus 20, and display data of an association relationship between a stakeholder and a resource, data of an association relationship between an activity and a resource, data of an association relationship between a stakeholder and an activity, and data of a transaction relationship between stakeholders, where the display device may be a display, a printer, or an information generation apparatus; and

a business model description apparatus 50, as described in the specific implementation manner corresponding to FIG. 6, configured to receive the stakeholder information of the organization, the resource information owned by the organization, the activity information of the organization, and the information of the transaction mode between stakeholders of the organization, which are transmitted by the user interface adapter 30 through the bus 20, generate data of an association relationship between a stakeholder and a resource, data of an association relationship between an activity and a resource, data of an association relationship between a stakeholder and an activity, and data of a transaction relationship between stakeholders, and transmit the data to the display adapter 40 through the bus 20.

The business model description apparatus 50 may be implemented by hardware, or implemented by software, or implemented by a combination of software and hardware.

The apparatus is not described exhaustively herein. For detailed information, reference may be made to the detailed description in the specific implementation manner of the apparatus for describing a business model.

In specific implementation manners of a method and an apparatus for describing a business model according to the present invention, a stakeholder, a resource, an activity, and a transaction mode of an organization are input, and a corresponding association relationship between every two thereof is generated for describing an existing business model of the organization, and thereby an effective quantitative analysis method or apparatus is provided for describing the business model of the organization.

A person of ordinary skill in the art understands that each aspect of the present invention or a possible implementation manner of each aspect may be specifically implemented as a system, a method, or a computer program product. Therefore, each aspect of the present invention or the possible implementation manner of each aspect may use a form of hardware only embodiments, software only embodiments (including firmware, resident software, and the like), or embodiments with a combination of software and hardware, which are collectively called “a circuit”. “a module”, or “a system”. In addition, each aspect of the present invention or the possible implementation manner of each aspect may use a form of a computer program product, where the computer program product refers to computer readable program code stored in a computer readable medium.

The computer readable medium may be a computer readable signal medium or a computer readable storage medium. A computer readable storage medium includes but is not limited to an electronic, magnetic, optical, electromagnetic, infrared, or semiconductor system, device, or apparatus, or any suitable combination of the foregoing, for example, a random access memory (RAM), a read-only memory (ROM), an erasable programmable read-only memory (EPROM or flash memory), an optical fiber, or a portable compact disc read-only memory (CD-ROM).

A processor in a computer reads the computer readable program code stored in the computer readable medium, so that the processor can execute each step in the flowchart or function actions specified in a combination of steps, and generate an apparatus for implementing each block in a block diagram or function actions specified in a combination of blocks.

The computer readable program code may be completely executed on a computer of a user, or partially executed on a computer of a user, or as an independent software package, partially executed on a computer of a user and partially executed on a remote computer, or completely executed on a remote computer or a server. It should also be noted that in some alternative implementation solutions, each step in the flowchart or the function indicated by each block in the block diagram may occur not in accordance with the sequence indicated in the drawing. For example, two steps or two blocks that are connected and shown depending on involved functions may be actually executed approximately at the same time, or sometimes these blocks may be executed in a reverse sequence.

It is apparent to a person skilled in the art that various modifications and variations can be made to the present invention without departing from the scope or spirit of the present invention. The present invention is intended to cover these modifications and variations provided that they fall within the scope of protection defined by the following claims and their equivalent technologies.

What is claimed is:

1. A method for describing a business model of an organization, wherein the method comprises the following steps:
generating data of an association relationship between a stakeholder and a resource according to stakeholder information of the organization and resource information owned by the organization;
generating data of an association relationship between an activity and a resource according to activity information of the organization and the resource information owned by the organization;
generating data of an association relationship between a stakeholder and an activity according to the stakeholder information of the organization and the activity information of the organization; and
generating data of a transaction relationship between stakeholders according to information of a transaction mode between stakeholders of the organization; wherein
the resources are features that are controlled by the organization to implement a strategy of the organization and used to improve operational performance and efficiency of the organization, and the activities are specific actions of various stakeholders of the organization.

2. The method for describing a business model according to claim 1, wherein the data of an association relationship between a stakeholder and a resource is determined according to the following expression:
$$\frac{Level}{Owned}$$
wherein, Owned indicates whether the stakeholder owns the resource, and Level indicates a level of ownership or control of the stakeholder over the resource.

3. The method for describing a business model according to claim 1, wherein the data of an association relationship between an activity and a resource is determined according to the following expression:
$$\frac{Input Process Output}{Required} , Capacity , Rank$$
wherein, Required indicates whether the activity requires the resource;
Input, Process, and Output respectively indicate whether the resource may be used in input, processing, and generation of the activity,
Capacity indicates a capacity formed in the activity by using the resource; and
Rank indicates strength and stability of the capacity formed in the activity by using the resource.

4. The method for describing a business model according to claim 1, wherein the data of an association relationship between a stakeholder and an activity is determined according to the following expression:
$$\frac{Capacity Rank}{Participated}$$
wherein, Participated indicates whether the stakeholder participates in the activity;
Capacity indicates a capacity formed by the stakeholder by participating in the activity; and
Rank indicates strength and stability of the capacity formed by the stakeholder by participating in the activity.

5. The method for describing a business model according to claim 1, wherein the transaction mode between stakeholders is determined according to the following expression:
$$\frac{{T}_{1} \text{∼} {T}_{i}}{G}$$
wherein, T₁ to Tᵢ are identifiers of attribute information of the transaction mode between stakeholders, and i is a natural number greater than or equal to 1; and
G is a governing relationship between entities, and the entities comprise the organization and stakeholders.

6. The method for describing a business model according to claim 5, wherein the attribute information of the transaction mode between stakeholders comprises:
information of a mode that meets a requirement;
revenue and expenditure source information of a transaction;
revenue and expenditure mode information of the transaction;
cash flow structure information of the transaction;
information of roles of stakeholders in the transaction; and
information of a transaction structure between stakeholders in the transaction.

7. An apparatus for describing a business model of an organization, wherein the apparatus comprises:
a stakeholder-resource association relationship data generation unit, configured to generate data of an association relationship between a stakeholder and a resource according to stakeholder information of the organization and resource information owned by the organization;
an activity-resource association relationship data generation unit, configured to generate data of an association relationship between an activity and a resource according to activity information of the organization and the resource information owned by the organization;
a stakeholder-activity association relationship data generation unit, configured to generate data of an association relationship between a stakeholder and an activity according to the stakeholder information of the organization and the activity information of the organization; and
a stakeholder transaction relationship data generation unit, configured to generate data of a transaction relationship between stakeholders according to information of a transaction mode between stakeholders of the organization; wherein
the resources are features that are controlled by the organization to implement a strategy of the organization and used to improve operational performance and efficiency of the organization; and
the activities are actions of stakeholders of the organization.

8. The apparatus for describing a business model according to claim 7, wherein the data of an association relationship between a stakeholder and a resource is determined according to the following expression:
$$\frac{Level}{Owned}$$
wherein, Owned indicates whether the stakeholder owns the resource, and Level indicates a level of ownership or control of the stakeholder over the resource.

9. The apparatus for describing a business model according to claim 7, wherein the data of an association relationship between an activity and a resource is determined according to the following expression:
$$\frac{Input Process Output}{Required} , Capacity , Rank$$
wherein, Required indicates whether the activity requires the resource;
Input, Process, and Output respectively indicate whether the resource may be used in input, processing, and generation of the activity;
Capacity indicates a capacity formed in the activity by using the resource; and
Rank indicates strength and stability of the capacity formed in the activity by using the resource.

10. The apparatus for describing a business model according to claim 7, wherein the data of an association relationship between a stakeholder and an activity is determined according to the following expression:
$$\frac{Capacity Rank}{Participated}$$
wherein, Participated indicates whether the stakeholder participates in the activity;
Capacity indicates a capacity formed by the stakeholder by participating in the activity; and
Rank indicates strength of the capacity formed by the stakeholder by participating in the activity.

11. The apparatus for describing a business model according to claim 7, wherein the transaction mode between stakeholders is determined according to the following expression:
$$\frac{{T}_{1} \text{∼} {T}_{i}}{G}$$
wherein, T₁ to Tᵢ are identifiers of attribute information of the transaction mode between stakeholders, and i is a natural number greater than or equal to 1; and
G is a governing relationship between entities, and the entities comprise the organization and stakeholders.

12. The apparatus for describing a business model according to claim 11, wherein the attribute information of the transaction mode between stakeholders comprises:
information of a mode that meets a requirement;
revenue and expenditure source information of a transaction;
revenue and expenditure mode information of the transaction;
cash flow structure information of the transaction;
information of roles of stakeholders in the transaction; and
information of a transaction structure between stakeholders.

13. A system for describing a business model of an organization, wherein the system comprises:
a bus, configured to transmit signaling and data;
a user interface adapter, configured to connect an input device to the bus, and receive stakeholder information of the organization, resource information owned by the organization, activity information of the organization, and information of a transaction mode between stakeholders of the organization, which are input by a user;
a display adapter, configured to connect a display device to the bus, and display data of an association relationship between a stakeholder and a resource, data of an association relationship between an activity and a resource, data of an association relationship between a stakeholder and an activity, and data of a transaction relationship between stakeholders; and
a business model description apparatus, configured to receive the stakeholder information of the organization, the resource information owned by the organization, the activity information of the organization, and the information of the transaction mode between stakeholders of the organization, which are transmitted by the user interface adapter through the bus, generate data of an association relationship between a stakeholder and a resource, data of an association relationship between an activity and a resource, data of an association relationship between a stakeholder and an activity, and data of a transaction relationship between stakeholders, and transmit the data to the display adapter through the bus.

14. The system for describing a business model according to claim 13, wherein the data of an association relationship between a stakeholder and a resource is determined according to the following expression:
$$\frac{Level}{Owned}$$
wherein, Owned indicates whether the stakeholder owns the resource, and Level indicates a level of ownership or control of the stakeholder over the resource.

15. The system for describing a business model according to claim 13, wherein the data of an association relationship between an activity and a resource is determined according to the following expression:
$$\frac{Input Process Output}{Required} , Capacity , Rank$$
wherein, Required indicates whether the activity requires the resource;
Input, Process, and Output respectively indicate whether the resource may be used in input, processing, and generation of the activity;
Capacity indicates a capacity formed in the activity by using the resource; and
Rank indicates strength and stability of the capacity formed in the activity by using the resource.

16. The system for describing a business model according to claim 13, wherein the data of an association relationship between a stakeholder and an activity is determined according to the following expression:
$$\frac{Capacity Rank}{Participated}$$
wherein, Participated indicates whether the stakeholder participates in the activity;
Capacity indicates a capacity formed by the stakeholder by participating in the activity; and
Rank indicates strength of the capacity formed by the stakeholder by participating in the activity.

17. The system for describing a business model according to claim 13, wherein the transaction mode between stakeholders is determined according to the following expression:
$$\frac{{T}_{1} \text{∼} {T}_{i}}{G}$$
wherein, T₁ to Tᵢ are identifiers of attribute information of the transaction mode between stakeholders, and i is a natural number greater than or equal to 1; and
G is a governing relationship between entities, and the entities comprise the organization and stakeholders.

18. The system for describing a business model according to claim 13, wherein the attribute information of the transaction mode between stakeholders comprises:
information of a mode that meets a requirement;
revenue and expenditure source information of a transaction;
revenue and expenditure mode information of the transaction;
cash flow structure information of the transaction;
information of roles of stakeholders in the transaction; and
information of a transaction structure between stakeholders.

19. A computer readable storage medium, wherein the computer readable storage medium stores a computer program instruction executable by a computer, and when the computer executes the computer program instruction, the computer executes a method for describing a business model, wherein the method for describing a business model comprises:
generating data of an association relationship between a stakeholder and a resource according to stakeholder information of an organization and resource information owned by the organization;
generating data of an association relationship between an activity and a resource according to activity information of the organization and the resource information owned by the organization;
generating data of an association relationship between a stakeholder and an activity according to the stakeholder information of the organization and the activity information of the organization; and
generating data of a transaction relationship between stakeholders according to information of a transaction mode between stakeholders of the organization; wherein
the resources are features that are controlled by the organization to implement a strategy of the organization and used to improve operational performance and efficiency of the organization, and the activities are actions of stakeholders of the organization.

20. The computer readable storage medium according to claim 19, wherein the data of an association relationship between a stakeholder and a resource is determined according to the following expression:
$$\frac{Level}{Owned}$$
wherein, Owned indicates whether the stakeholder owns the resource, and Level indicates a level of ownership or control of the stakeholder over the resource.

21. The computer readable storage medium according to claim 19, wherein the data of an association relationship between an activity and a resource is determined according to the following expression:
$$\frac{Input Process Output}{Required} , Capacity , Rank$$
wherein, Required indicates whether the activity requires the resource;
Input, Process, and Output respectively indicate whether the resource may be used in input, processing, and generation of the activity;
Capacity indicates a capacity formed in the activity by using the resource; and
Rank indicates strength and stability of the capacity formed in the activity by using the resource.

22. The computer readable storage medium according to claim 19, wherein the data of an association relationship between a stakeholder and an activity is determined according to the following expression:
$$\frac{Capacity Rank}{Participated}$$
wherein, Participated indicates whether the stakeholder participates in the activity;
Capacity indicates a capacity formed by the stakeholder by participating in the activity; and
Rank indicates strength of the capacity formed by the stakeholder by participating in the activity.

23. The computer readable storage medium according to claim 19, wherein the transaction mode between stakeholders is determined according to the following expression:
$$\frac{{T}_{1} \text{∼} {T}_{i}}{G}$$
wherein, T₁ to Tᵢ are identifiers of attribute information of the transaction mode between stakeholders, and i is a natural number greater than or equal to 1; and
G is a governing relationship between entities, and the entities comprise the organization and stakeholders.

24. The computer readable storage medium according to claim 23, wherein the attribute information of the transaction mode between stakeholders comprises:
information of a mode that meets a requirement;
revenue and expenditure source information of a transaction;
revenue and expenditure mode information of the transaction;
cash flow structure information of the transaction;
information of roles of stakeholders in the transaction; and
information of a transaction structure between stakeholders in the transaction.
